(19) United States
(12) Patent Application Publication
(10) Pub. No.: US 2025/0307705 A1
(43) Pub. Date: Oct. 2, 2025

(54) MODEL PROCESSING METHOD, VOICE INTERACTION METHOD, ELECTRONIC DEVICE, AND STORAGE MEDIUM

(71) Applicant: Beijing Baidu Netcom Science Technology Co., Ltd., Beijing (CN)

(72) Inventors: Le ZHANG, Beijing (CN); Jingbo ZHOU, Beijing (CN); Jizhou HUANG, Beijing (CN)

(21) Appl. No.: 18/894,121

(22) Filed: Sep. 24, 2024

(30) Foreign Application Priority Data
Apr. 1, 2024 (CN) 202410390627.6

(51) Int. Cl. G06N 20/00

(52) U.S. Cl. CPC G06N 20/00

(57) ABSTRACT

Provided is a model processing method, a voice interaction method, an electronic device and a storage medium, relating to fields of artificial intelligence, big data and voice technologies. The model processing method includes: obtaining a candidate question set of each initial sample data in M initial sample data, wherein the initial sample data includes m rounds of question-and-answer between an object and an agent, the candidate question set includes a next round of question set corresponding to the m^{th} round of question in the m rounds of question-and-answer; obtaining M training sample data based on the M initial sample data, the candidate question set and label data of each initial sample data, wherein the label data includes a target question to be generated by the agent in the (m+1)^{th} round; and training a model to be trained by using the M training sample data to obtain a target model.

### CROSS-REFERENCE TO RELATED APPLICATIONS

The present application claims the priority from Chinese Patent Application No. 2024103906276, filed with the Chinese Patent Office on Apr. 1, 2024, the content of which is hereby incorporated herein by reference in its entirety.

### TECHNICAL FIELD

The present disclosure relates to the field of data processing technologies, and in particular, to the technical fields of artificial intelligence, big data, and voice technologies.

### BACKGROUND

An intelligent voice assistant refers to a conversational agent designed to engage in multi-round dialogues. This conversational agent communicates with an object through understanding, active inquiry, and clarification, thereby achieving a specific objective (such as information collection or targeted research). With the development of AI technologies fused with deep learning, the capability of the intelligent voice agent has become increasingly advanced, and the intelligent voice agent can communicate with the object in a fully automated manner throughout the entire process. Currently, the agent is widely applied in various fields, such as smart customer service.

### SUMMARY

The present disclosure provides a model processing method and apparatus, a voice interaction method and apparatus, a device and a storage medium.

According to an aspect, provided is a model processing method, including:
obtaining a candidate question set of each initial sample data in M initial sample data, wherein the initial sample data includes m rounds of question-and-answer between an object and an agent, the candidate question set of the initial sample data includes a next round of question set corresponding to the m^{th} round of question in the m rounds of question-and-answer, and M and m are both positive integers greater than or equal to 1;
obtaining M training sample data based on the M initial sample data, the candidate question set of each initial sample data and label data of each initial sample data, wherein the label data of the initial sample data includes a target question to be generated by the agent in the (m+1)^{th} round; and
training a model to be trained by using the M training sample data to obtain a target model capable of predicting a question to be generated by the agent in a next round based on historical questions and answers.

According to another aspect of the present disclosure, provided is a voice interaction method, including:
obtaining target text data, wherein the target text data is obtained based on a speech answer of an object in a previous round of question between the object and an agent;
obtaining a candidate question set in a next round for a question addressed by the target text data; and
inputting the target text data and the candidate question set in the next round for the question addressed by the target text data into a target model to obtain a text question to be generated by the agent.

According to still another aspect of the present disclosure, provided is a model processing apparatus, including:
a data processing unit, configured to obtain a candidate question set of each initial sample data in M initial sample data, wherein the initial sample data includes m rounds of question-and-answer between an object and an agent, the candidate question set of the initial sample data includes a next round of question set corresponding to the m^{th} round of question in the m rounds of question-and-answer, and M and m are both positive integers greater than or equal to 1; and obtain M training sample data based on the M initial sample data, the candidate question set of each initial sample data and label data of each initial sample data, wherein the label data of the initial sample data includes a target question to be generated by the agent in the (m+1)^{th} round; and
a model training unit, configured to train a model to be trained by using the M training sample data to obtain a target model capable of predicting a question to be generated by the agent in a next round based on historical questions and answers.

According to yet another aspect of the present disclosure, provided is a voice interaction apparatus, including:
an obtaining unit, configured to obtain target text data, wherein the target text data is obtained based on a speech answer of an object in a previous round of question between the object and an agent, and to obtain a candidate question set in a next round for a question addressed by the target text data; and
a model prediction unit, configured to input the target text data and the candidate question set in the next round for the question addressed by the target text data into a target model to obtain a text question to be generated by the agent.

According to yet another aspect of the present disclosure, provided is an electronic device, including:
at least one processor; and
a memory connected in communication with the at least one processor.

The memory stores an instruction executable by the at least one processor, and the instruction, when executed by the at least one processor, enables the at least one processor to execute the method of any embodiment of the present disclosure.

According to yet another aspect of the present disclosure, provided is a non-transitory computer-readable storage medium storing a computer instruction thereon, and the computer instruction is used to cause a computer to execute the method of any embodiment of the present disclosure.

According to yet another aspect of the present disclosure, provided is a computer program product including a computer program, and the computer program implements the method of any embodiment of the present disclosure, when executed by a processor.

Therefore, according to the scheme of the present disclosure, the M training sample data can be obtained based on the M initial sample data, the candidate question set of each initial sample data and the label data of each initial sample data to train the model to be trained, so that the model to be trained can perform reasoning within a specified range (such as the candidate question set) to achieve dialogue management, and meanwhile, an illusion problem of the model during the generation process can be effectively avoided, thereby further improving the reasoning speed of the model and effectively enhancing user experience.

It should be understood that the content described in this part is not intended to identify critical or essential features of embodiments of the present disclosure, nor is it used to limit the scope of the present disclosure. Other features of the present disclosure will be easily understood through the following description.

### BRIEF DESCRIPTION OF THE DRAWINGS

The accompanying drawings are used to better understand the present solution, and do not constitute a limitation to the present disclosure, in which:

FIG. 1 is a block diagram illustrating an architecture framework for an intelligent voice assistant based on a modular design;

FIG. 2 is a first flow chart schematically illustrating a model processing method according to an embodiment of the present disclosure;

FIG. 3 is a schematic diagram of the model training scenario according to the embodiment of the present disclosure;

FIG. 4(a) is a second flow chart schematically illustrating a model processing method according to an embodiment of the present disclosure;

FIGS. 4(b) to 4(d) are exemplary diagrams of finite state machines used in the model processing method according to the embodiment of the present disclosure;

FIG. 5 is a third flow chart schematically illustrating a model processing method according to an embodiment of the present disclosure;

FIG. 6(a) is a flow chart schematically illustrating a voice interaction method according to an embodiment of the present disclosure;

FIG. 6(b) is a schematic diagram of a scenario of the voice interaction method according to the embodiment of the present disclosure;

FIG. 7 is a flow chart schematically illustrating a model processing method in a specific example according to an embodiment of the present disclosure;

FIG. 8 is a block diagram schematically illustrating a model processing apparatus according to an embodiment of the present disclosure;

FIG. 9 is a block diagram schematically illustrating a voice interaction apparatus according to an embodiment of the present disclosure; and

FIG. 10 is a block diagram of an electronic device used to implement the model processing method according to the embodiment of the present disclosure.

### DETAILED DESCRIPTION

Hereinafter, descriptions to exemplary embodiments of the present disclosure are made with reference to the accompanying drawings, include various details of the embodiments of the present disclosure to facilitate understanding, and should be considered as merely exemplary. Therefore, those having ordinary skill in the art should realize, various changes and modifications may be made to the embodiments described herein, without departing from the scope and spirit of the present disclosure. Likewise, for clarity and conciseness, descriptions of well-known functions and structures are omitted in the following descriptions.

The term “and/or” herein only describes an association relation of associated objects, which indicates that there may be three kinds of relations. For example, A and/or B may indicate that there is only A exists, or there are both A and B exist, or there is only B exists. The term “at least one” herein indicates any one of many items, or any combination of at least two of the many items. For example, at least one of A, B, or C may indicate any one or more elements selected from a set of A, B, and C. The term “first” and “second” herein indicate a plurality of similar technical terms and use to distinguish them from each other, but do not limit an order of them or limit that there are only two items. For example, a first feature and a second feature indicate two types of features/two features, a quantity of the first feature may be one or more, and a quantity of the second feature may also be one or more.

In addition, in order to better illustrate the present disclosure, numerous specific details are given in the following specific implementations. Those having ordinary skill in the art should be understood that the present disclosure may be performed without certain specific details. In some examples, methods, means, elements and circuits well known to those having ordinary skill in the art are not described in detail, in order to highlight the subject matter of the present disclosure.

The related arts in accordance with the embodiments of the present disclosure will be described below. The related arts, as optional solutions, can be combined arbitrarily with the technical schemes of the embodiments of the present disclosure, and all such combinations fall within the protection scope of the embodiments of the present disclosure.

An intelligent voice assistant refers to a conversational agent designed to engage in multi-round dialogues. This conversational agent communicates with an object through understanding, active inquiry, and clarification, thereby achieving a specific objective (such as information collection or targeted research). With the development of AI technologies fused with deep learning, the capability of the intelligent voice agent has become increasingly advanced, and the intelligent voice agent can communicate with the object in a fully automated manner throughout the entire process. Currently, the agent is widely applied in various fields, such as smart customer service.

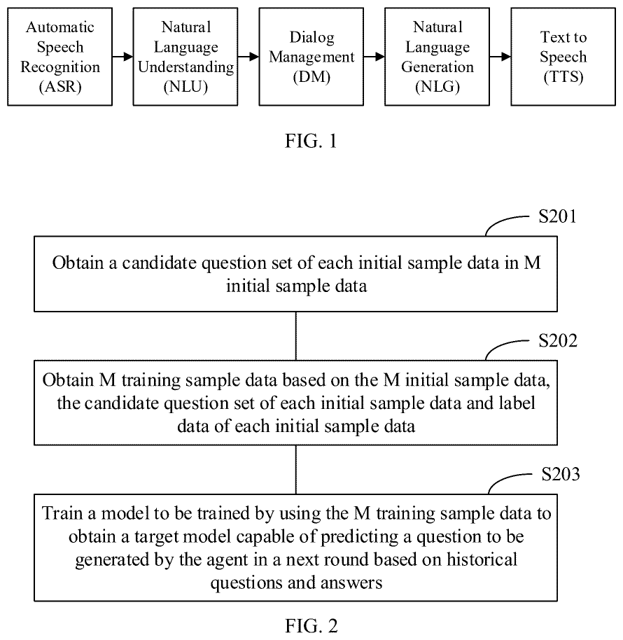

In general, the intelligent voice assistant deployed in applications mainly adopts modular design, and as shown in FIG. 1, mainly includes the following independent modules:
(1) Natural Language Understanding (NLU) module, which is used for understanding speaking content of the object and recognizing intention of the object, for example.
(2) Dialog Management (DM) module, which is used for determining a subject of the next dialog based on an understanding of the speaking content of the object.
(3) Natural Language Generation (NLG) module, which is used for generating subsequent conversational content.

In addition, in order to realize conversion between voice and text, the intelligent voice assistant may further include:
(a) Automatic Speech Recognition (ASR) module, which is for converting speech data of the object into text content.
(b) Text to Speech (TTS) module, which is used for converting the text content output from the voice intelligent agent into the speech data.

The modular design of the intelligent voice assistant is intended to split the whole dialog management process into a plurality of modules, each of which is only responsible for a specific function. But the modular design has certain limitations. For example, a problem of error accumulation exists, namely, an error of a former module may be accumulated to a latter module, so that the error may be amplified; in addition, the modular design also increases maintenance cost and service update cost.

Based on this, the present disclosure provides a scheme of intelligent voice assistant based on LLM, which can utilize the powerful language understanding capability, scheduling capability and generating capability of the large model to implement a dialog control in an end-to-end manner, for example, replacing multiple modules (e.g., NLU, DM and NLG) for word processing in the intelligent voice assistant with the LLM. Thus, the problem of error accumulation, high maintenance cost and high service updating cost can be solved.

Here, in order to implement the dialog control in the end-to-end manner, the present disclosure provides a model processing scheme so that a trained LLM has end-to-end dialog management capability, and the present disclosure further effectively improves the accuracy of an output result, thereby effectively improving the user experience.

Specifically, FIG. 2 is a first flow chart schematically illustrating a model processing method according to an embodiment of the present disclosure. The method is optionally applied to an electronic device such as a personal computer, a server, and a server cluster.

Further, the method includes at least some of the following contents, as shown in FIG. 2, including:

Step S201: a candidate question set of each initial sample data in M initial sample data is obtained.

Here, in this example, the initial sample data includes m rounds of question-and-answer between an object and an agent (e.g., an intelligent voice agent); further, one of the m rounds of question-and-answer between the object and the agent includes a question generated by the agent and an answer content of the object.

It should be noted that m corresponding to different initial sample data may be same or different. In other words, the number of conversational rounds may be same or different for different initial sample data.

For example, given that a question generated by the agent is denoted as Q, an answer content of the object is denoted as A, and a question-and-answer (also called dialogue) between the agent and the object is denoted as C, then m rounds of question-and-answer (i.e., m rounds of dialogue) between the object and the agent can be specifically expressed as:

C_{[1,m]}=(Q₁,A₁;Q₂,A₂; . . . ;Qₖ,Aₖ; . . . ;Qₘ,Aₘ)

Here, (Qₖ, Aₖ) represents a round of question-and-answer between the object and the agent within m rounds of question-and-answer, i.e., the k^{th} round of question-and-answer, Qₖ represents a question generated by the agent in the k^{th} round of question-and-answer, and Aₖ represents an answer content of the object to Qₖ in the k^{th} round of question-and-answer.

Further, in this example, the candidate question set of the initial sample data may specifically include a next round of question set corresponding to the m^{th} round of question in the m rounds of question-and-answer.

Here, M and m are both positive integers greater than or equal to 1; it is understood that values of M and m are independent.

For example, continuing with the context of m rounds of question-and-answer C_{[1,m]} between the object and the agent, if the initial sample data is m rounds of question-and-answer C_{[1,m]}, then the candidate question set for the initial sample data is a next round of question set {Q_{m+1,1}, Q_{m+1, 2}, . . . } corresponding to the m^{th} question Qₘ in the m rounds of question-and-answer C_{[1,m]}.

Step S202: M training sample data are obtained based on the M initial sample data, the candidate question set of each initial sample data and label data of each initial sample data.

Here, under the condition that the initial sample data includes m rounds of question-and-answer, the label data of the initial sample data specifically includes a target question to be generated by the agent in the (m+1)^{th} round.

In other words, the label data of the initial sample data is the target question to be generated by the agent in the next round with respect to the latest round of question-and-answer included in the initial sample data.

Step S203: a model to be trained is trained by using the M training sample data to obtain a target model capable of predicting a question to be generated by the agent in a next round based on historical questions and answers.

Here, in an example, the model to be trained according to the present disclosure is a large language model. For example, it is a large language model with a number of adjustable parameters below a preset threshold, which helps to effectively reduce a reasoning time and lay foundation for improving the user experience.

Therefore, according to the scheme of the present disclosure, the M training sample data can be obtained based on the M initial sample data, the candidate question set of each initial sample data and the label data of each initial sample data to train the model to be trained, so that the model to be trained can perform reasoning within a specified range (such as the candidate question set) to achieve dialogue management, and meanwhile, an illusion problem of the model during the generation process can be effectively avoided, thereby further improving the reasoning speed of the model and effectively enhancing user experience.

In addition, it should be noted that, since the large language model with stronger reasoning capability can be used in the present disclosure, the accuracy of the output result of the target model can be effectively improved and the user experience is further enhanced. In addition, in the application scene of the intelligent voice assistant, the scheme of the disclosure also effectively avoids the problems of error accumulation, high maintenance cost and high service updating cost caused by the modular design.

Further, in a specific example, the following training mode can be adopted to train the model to be trained; in particular, the above operation of training the model to be trained by using the M training sample data to obtain the target model capable of predicting the question to be generated by the agent in a next round based on historical questions and answers (for example, Step S203 as stated above) may specifically include:

Step S203-1: the m rounds of question-and-answer included in the training sample data and the candidate question set corresponding to the m^{th} round of question included in the training sample data (namely, the next round of question set corresponding to the m^{th} round of question) are input into a model to be trained to obtain an initial estimation result. Here, the initial estimation result represents the predicted question to be generated by the agent in the (m+1)^{th} round.

In this example, the training sample data may specifically include the initial sample data, the candidate question set of the initial sample data, and the label data of the initial sample data. For instance, in an example, a piece of training sample data may specifically include: m rounds of question-and-answer between an object and an agent, a next round of question set corresponding to the m^{th} round of question in the m rounds of question-and-answer, and a target question (label data) to be generated by the agent in the (m+1)^{th} round of question. In this regard, m corresponding to different training sample data may be same or different. Therefore, the model to be trained is trained based on a plurality of training sample data constructed in the above way, which allows the model to effectively realize dialogue management while solving the related problems of the above modular design on the basis of efficiently reasoning to obtain the problems to be generated by the agent.

Step S203-2: a loss value of a loss function is obtained based on the initial estimation result and the target question to be generated by the agent in the (m+1)^{th} round included in the label data in the training sample data.

Here, the loss function can represent a distance between the predicted question and the target question.

Step S203-3: at least part of adjustable parameters in the model to be trained is adjusted based on the loss value of the loss function to obtain the target model by training.

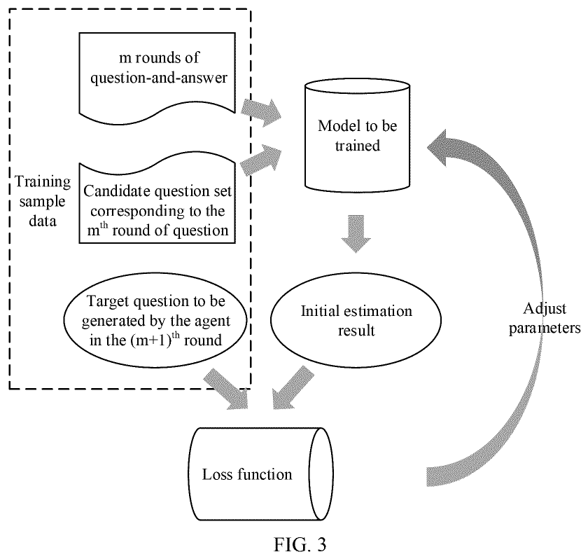

In other words, in an example as shown in FIG. 3, firstly, the m rounds of question-and-answer included in the training sample data and the candidate question set corresponding to the m^{th} round of question included in the training sample data are input into the model to be trained to obtain the initial estimation result; secondly, the loss function value between the initial estimation result and the target question to be generated by the agent in the (m+1)^{th} round in the label data is obtained by calculating; then the adjustable parameter of the model to be trained is adjusted according to the obtained loss function value; and the operations are repeated until a preset iteration number is reached or the loss function value meets a preset requirement (for example, the loss function value is converged to a specified value), so as to obtain the target model.

Therefore, the present disclosure provides a specific scheme of the model training, which is simple, convenient and efficient, so that the model to be trained can perform reasoning within a specified range (such as the candidate question set) to achieve dialogue management, and meanwhile, an illusion problem of the model during the generation process can be effectively avoided, thereby further improving the reasoning speed of the model and effectively enhancing the user experience.

Moreover, since the model performs the reasoning within the specified range without newly generating a question, the training method according to the present disclosure also effectively saves the computing resource and further improves the efficiency of the model training.

Further, in a specific example, the model to be trained may be used in the following manner; in particular, that is, the inputting the m rounds of question-and-answer included in the training sample data and the candidate question set corresponding to the m^{th} round of question included in the training sample data into the model to be trained (for example, Step S203-1 as stated above) specifically includes:

Step S203-1-1: a target cue word question is obtained based on the m rounds of question-and-answer included in the training sample data and the candidate question set corresponding to the m^{th} round of question included in the training sample data.

Here, in this example, a cue word template may also be set in advance. In this regard, after the data to be input to the model is determined, the target cue word question may be obtained by using the cue word template, thereby further improving the efficiency of the model processing.

It should be noted that the cue word template may be designed based on actual needs, which is not limited in the disclosure.

Step S203-1-2: the target cue word question is input into the model to be trained.

Therefore, the scheme of the disclosure can input the m rounds of question-and-answer included in the training sample data and the candidate question set corresponding to the m^{th} round of question included in the training sample data (namely, the next round of question set corresponding to the m^{th} round of question) into the model to be trained in the form of target cue word question, so that the model to be trained can obtain an appropriate question from the candidate question set as an output result. This allows the model to be trained to perform the reasoning within the specified range (such as the candidate question set), thereby improving the efficiency of the model training; moreover, since the model performs the reasoning within the specified range without newly generating a question, the training method according to the present disclosure can effectively save the computing resource, and effectively avoid the illusion problem of the target model during the generation process, thereby improving the reasoning speed of the model and effectively enhancing the user experience.

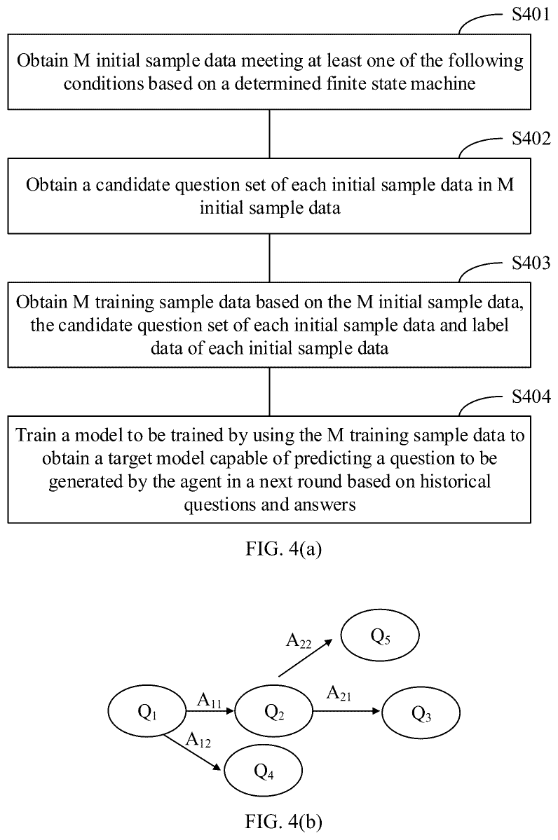

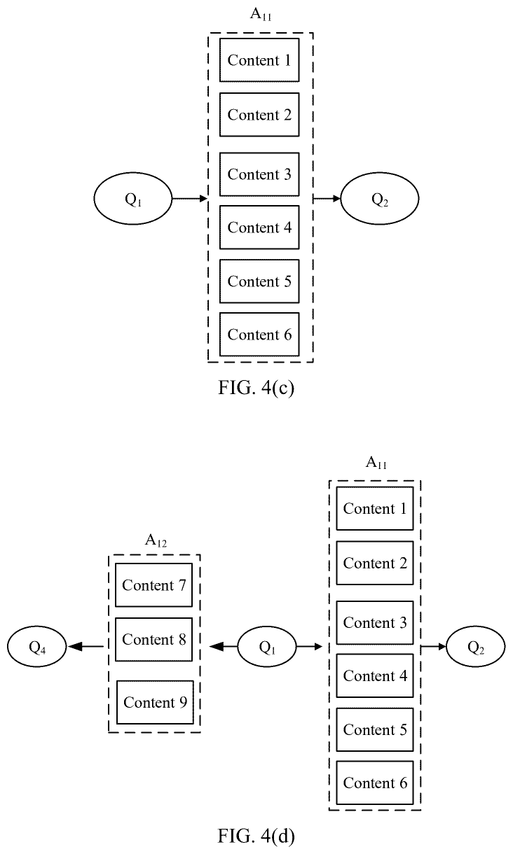

In particular, FIG. 4(a) is a schematic diagram illustrating a scenario of the model processing method according to the embodiment of the present disclosure. The method is optionally applied to an electronic device such as a personal computer, a server, and a server cluster. It can be understood that the related contents of the method shown in FIG. 2 as stated above can also be applied to this example and will not be described in detail herein.

Further, the method includes at least some of the following contents, as shown in FIG. 4(a), including:

Step S401: M initial sample data meeting at least one of the following conditions are obtained based on a determined finite state machine:

Data Condition I: in the M initial sample data, a distribution of the number of initial sample data with different lengths meets a first distribution requirement.

Here, a length of the initial sample data is determined based on a finite state machine and represents the number of rounds of question-and-answer.

Here, in an example, the first distribution requirement may be embodied as a uniform distribution. Alternatively, other distributions as determined based on training objectives are possible, which are not specifically limited by the present disclosure.

Data Condition II: in the M initial sample data, a distribution of an answer content of transferring from a previous question to a next question meets a second distribution requirement.

Here, in an example, the second distribution requirement may also be embodied as a uniform distribution. Alternatively, other distributions as determined based on training objectives are possible, which are not specifically limited by the present disclosure.

Further, in an example, the first distribution requirement and the second distribution requirement may both be uniform distribution. Or, in another example, the M initial sample data meet the two conditions, which helps to effectively solve the long-tail problem of data and effectively avoid the phenomenon that the model pays excessive attention to answers appearing in high frequency while weakening its processing capability of some unusual answers, thereby laying a foundation for further improving the accuracy of the reasoning result of the model.

Here, the finite state machine can represent a group of questions generated by the agent and a transfer condition for transferring from a current question to a next question; the transfer condition is related to the answer content of the object to reply to the current question. In other words, the finite state machine gives a circulation path between the question and the answer content. For example, the candidate question set corresponding to the m^{th} round of question as described above may be determined specifically based on the given finite state machine, so as to further achieve the effective management of the dialogue process by the model while further improving the efficiency of the model reasoning.

Step S402: a candidate question set of each initial sample data in M initial sample data is obtained.

Here, the initial sample data includes m rounds of question-and-answer between an object and an agent; the candidate question set of the initial sample data includes a next round of question set corresponding to the m^{th} question in the m rounds of question-and-answer; M and m are both positive integers greater than or equal to 1. It should be noted that, for the description of the initial sample data, reference may be made to the above example, and details thereof will not be described herein.

Step S403: M training sample data are obtained based on the M initial sample data, the candidate question set of each initial sample data and label data of each initial sample data.

Here, the label data of the initial sample data includes a target question to be generated by the agent in the (m+1)^{th} round.

Step S404: a model to be trained is trained by using the M training sample data to obtain a target model capable of predicting a question to be generated by the agent in a next round based on historical questions and answers.

Therefore, according to the scheme of the present disclosure, the initial sample data meeting the requirements can be obtained based on the finite state machine, and then M training sample data can be obtained based on the obtained initial sample data to train the model to be trained, so that the finite state machine is utilized to constrain the reasoning process to realize effective management of the dialogue process, and meanwhile, an illusion problem of the model during the generation process can be effectively avoided, thereby further improving the reasoning speed of the model and effectively enhancing user experience.

Further, in a specific example, the finite state machine as described above may be determined as follows; specifically, before obtaining M initial sample data meeting at least one of the following conditions based on the determined finite state machine (for example, before Step S401 as described above), the method further includes:

Step S400: the finite state machine is determined based on N historical interaction data between the object and the agent.

Here, historical interaction data in the N historical interaction data includes m rounds of question-and-answer between the object and the agent and a question to be generated by the agent in the (m+1)^{th} round; and N is a positive integer greater than or equal to 1.

For example, FIG. 4(b) shows a specific example of a finite state machine. As shown in FIG. 4(b), the finite state machine includes 4 questions generated by the agent, which are Q₁-Q₅, respectively. The finite state machine also includes flow paths (also referred to as transfer paths) between the questions as shown by arrows in FIG. 4(b). Further, a transfer condition flowing (or transferring) from one question to the next question is related to answer content of the object to reply to the current question. For example, with respect to the question Q₁, when the answer content to the question Q₁ is A₁₁, a transfer is made to the question Q₂, and when the answer content to the question Q₁ is A₁₂, a transfer is made to the question Q₄. Similarly, with respect to the question Q₂, when the answer content to the question Q₂ is A₂₁, a transfer is made to the question Q₃, and when the answer content to the question Q₂ is A₂₂, a transfer is made to the question Q₅.

Here, a next round of question set corresponding to question Q₁ may include question Q₂ and question Q₄; similarly, a next round of question set corresponding to question Q₂ may include question Q₃ and question Q₅.

Further, Data Condition I will be further explained with reference to the finite state machine as illustrated in FIG. 4(b). For the finite state machine as illustrated in FIG. 4(b), the number of rounds of question-and-answer included in the historical interaction data (also known as historical dialogue data), denoted as m, can specifically take values of 1 and 2. For example, the historical interaction data can be (Q₁, A₁₂; Q₄), or the historical interaction data can be (Q₁, A₁₁; Q₂, A₂₂, Q₅), or the historical interaction data can be (Q₁, A₁₁; Q₂, A₂₁, Q₃). In this regard, to meet the requirement of Data Condition I, during the selection of all initial sample data, the number of initial sample data with different values of m follows the first distribution requirement. For instance, the number of initial sample data with a value of m=1 and the number of initial sample data with a value of m=2 comply with the first distribution requirement.

Further, Data Condition II will be further explained with reference to the finite state machine as illustrated in FIG. 4(b). As shown in FIG. 4(c), the answer content A₁₁ of transferring from the question Q₁ to the question Q₂ includes a plurality of cases including contents 1 to 6. In this regard, in order to avoid the long-tail problem, the number of different answer contents of transferring from the question Q₁ to the question Q₂ needs to meet the second distribution requirement. For example, for the different answer contents of transferring from the question Q₁ to the question Q₂, the number of contents 1, the number of contents 2, the data of contents 3, the number of contents 4, the number of contents 5, and the number of contents 6 need to meet the second distribution requirement. For example, the number of the above contents 6 needs to be equal.

In addition, it should also be noted that, as shown in FIG. 4(d), the answer content A₁₂ of transferring from the question Q₁ to the question Q₄ includes a plurality of cases, for example, including contents 7 to 9. In this regard, the number of answer contents of transferring from one question to different questions may also meet a third distribution requirement, for example, a uniform distribution. For example, the number of answer contents A₁₂ of transferring from the question Q₁ to the question Q₄ is equal to the number of answer contents A₁ of transferring from the question Q₁ to the question Q₂. Thus, the long-tail problem of data may be further solved.

Therefore, the initial sample data selected in the above manner can effectively solve the long-tail problem of the data, and further effectively avoid the phenomenon that the model pays excessive attention to the answers appearing in high frequency while weakening its processing capacity of some unusual answers, thereby providing effective support for further improving the accuracy of the reasoning result of the model.

Moreover, the finite state machine in the scheme of the present disclosure is constructed based on the historical interaction data, which provides support for selecting initial sample data meeting the conditions, thereby laying a foundation for realizing effective management of a dialogue process, improving reasoning speed of the model and enhancing the user experience.

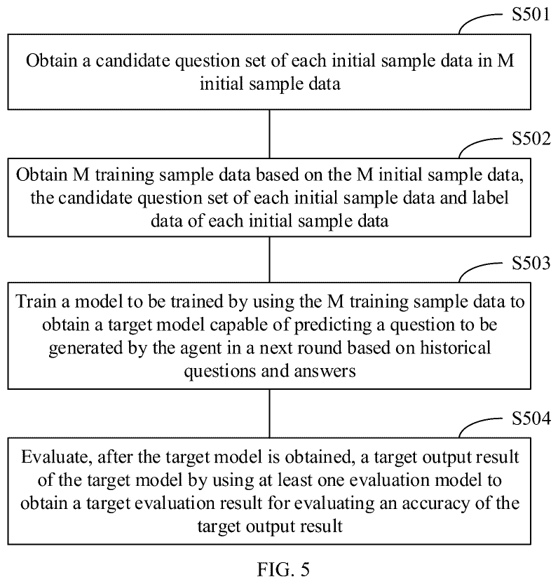

In particular, FIG. 5 is a third flow chart schematically illustrating a model processing method according to an embodiment of the present disclosure. The method is optionally applied to an electronic device such as a personal computer, a server, and a server cluster. It can be understood that the related contents of the methods shown in FIGS. 1 to 4 as stated above can also be applied to this example and will not be described in detail herein.

Further, the method includes at least some of the following contents, as shown in FIG. 5, including:

Step S501: a candidate question set of each initial sample data in M initial sample data is obtained.

Here, in this example, the initial sample data contains m rounds of question-and-answer between an object and an agent.

Further, in this example, the candidate question set of the initial sample data includes a next round of question set corresponding to the m^{th} question in the m rounds of question-and-answer.

Here, M and m are both positive integers greater than or equal to 1.

Step S502: M training sample data are obtained based on the M initial sample data, the candidate question set of each initial sample data and label data of each initial sample data.

Here, the label data of the initial sample data includes a target question to be generated by the agent in the (m+1)^{th} round.

Step S503: a model to be trained is trained by using the M training sample data to obtain a target model capable of predicting a question to be generated by the agent in a next round based on historical questions and answers.

Step S504: after the target model is obtained, a target output result of the target model is evaluated by using at least one evaluation model to obtain a target evaluation result for evaluating an accuracy of the target output result.

In other words, according to the scheme of the present disclosure, after the target model is obtained, the trained target model can be evaluated by using the evaluation model, which helps to lay a foundation for further improving the reasoning accuracy of the target model, and meanwhile, to lay a foundation for further enhancing the user experience.

It should be noted that the evaluation model for evaluating the accuracy of the target output result is a trained model, for example, a model obtained by training a large language model, so as to ensure the reasonability and the accuracy of the evaluation result.

In a specific example, an evaluation model in the at least one evaluation model meets at least one of the following conditions:

Model Condition I: under the condition that a parameter of the evaluation model is adjustable (for example, under the condition that the evaluation model is a trainable large language model), a parameter quantity of adjustable parameters of the evaluation model is greater than a parameter quantity of adjustable parameters of the target model, and the evaluation model is obtained by being trained based on the M training sample data.

Here, it should be noted that the training mode of the evaluation model may be the same as the training mode of the model to be trained, so that the evaluation model has a question generation capability similar to that of the target model; moreover, since the parameter quantity of the adjustable parameters of the evaluation model is larger than the parameter quantity of the adjustable parameters of the model to be trained, the evaluation model has stronger comprehension and higher accuracy.

In an example, the model to be trained and the evaluation model are both large language models, and the evaluation model has a larger parameter quantity of the adjustable parameter than the model to be trained.

Further, in a specific example, if the evaluation model is an evaluation model meeting the Model Condition I, then, after the target model is obtained, the evaluating the target output result of the target model by using at least one evaluation model to obtain the target evaluation result for evaluating the accuracy of the target output result (i.e., the above Step S504) specifically includes:

after the target model is obtained and under the condition that the evaluation model is obtained by being trained based on the M training sample data, evaluating the target output result of the target model based on the evaluation model (i.e., the evaluation model meeting the Model Condition I) to obtain an initial evaluation result corresponding to the evaluation model, wherein the initial evaluation result for the evaluation model is used to measure the accuracy of the target output result of the target model.

Therefore, the present disclosure provides a specific scheme for evaluating the target output result of the target model by using the evaluation model meeting the Model Condition I. This scheme can effectively evaluate the target model, which helps to lay a foundation for further improving the reasoning accuracy of the target model, and meanwhile, to lay a foundation for further enhancing the user experience.

Here, in an example, the initial evaluation result corresponding to the evaluation model is represented by a value: likelihood that the trained evaluation model (e.g., the evaluation model trained based on the M training sample data as described above) outputs the target output result outputted from the target model.

For instance, in a specific example, the likelihood that the trained evaluation model outputs the target output result outputted from the target model can be expressed by a formula:

P(Y*|X, [symbol] (Θ′)),

wherein P(Y*|X, [symbol] (Θ′)) represents a conditional probability that the trained evaluation model (denoted as [symbol] (Θ′)) outputs the target output result Y* of the target model, that is, a conditional probability that the output result is Y* when X is input into the trained evaluation model, where Y* represents the target output result when X is input into the trained target model. For instance, in an example, X represents the m rounds of question-and-answer included in the training sample data and the candidate question set corresponding to the m^{th} round of question included in the training sample data.

Therefore, the present disclosure provides a specific scheme for evaluating the target output result of the target model by using the evaluation model meeting the Model Condition I and the scheme is simple and convenient and has strong interpretability, which helps to lay a foundation for further improving the reasoning accuracy of the target model, and meanwhile, to lay a foundation for further enhancing the user experience.

Model Condition II: under the condition that the parameter of the evaluation model is adjustable, the parameter quantity of the adjustable parameters of the evaluation model is greater than the parameter quantity of the adjustable parameters of the target model, and the evaluation model is obtained by being trained based on the M training sample data and a pre-constructed evaluation data set.

Here, it should be noted that, in order to further improve the evaluation performance of the evaluation model, not only the evaluation model has a question generation capability (for example, after training an evaluation model to be trained by using the training sample data (i.e., the above-mentioned M training sample data) that is the same as the model to be trained, the obtained evaluation model may have the question generation capability), but also the evaluation model has a discrimination capability (for example, after training the evaluation model to be trained by using the pre-constructed evaluation data set, the obtained evaluation model may also have the discrimination capability). Therefore, the accuracy of the evaluation result is further improved, which helps to lay a foundation for further improving the reasoning accuracy of the target model, and meanwhile, to lay a foundation for further enhancing the user experience.

Here, in a specific example, the pre-constructed evaluation data set includes a plurality of positive sample data and a plurality of negative sample data constructed based on the plurality of positive sample data;

The positive sample data in the plurality of positive sample data is obtained based on the initial sample data in the M initial sample data. For example, the positive sample data may specifically include m rounds of question-and-answer and a genuine question generated by the target model in the (m+1)^{th} round. Furthermore, the negative sample data constructed based on the positive sample data, such as the negative sample data constructed based on the m rounds of question-and-answer and the genuine question generated by the target model in the (m+1)^{th} round, includes m rounds of question-and-answer and a constructed fake question in the (m+1)^{th} round. For instance, in an example, the constructed evaluation data set is denoted as Dₑ^{t}, details of which will be discussed below and will not be described herein.

Therefore, the present disclosure provides a specific scheme for constructing the evaluation data set, the construction mode of which is simple and efficient, such that the evaluation model not only has the question generation capability, but also has the discrimination capability, which helps to further improve the performance of the evaluation model, and meanwhile, to lay a foundation for further improving the reasoning accuracy of the target model and further enhancing the user experience.

Further, in a specific example, if the evaluation model is an evaluation model meeting the Model Condition II, then, after the target model is obtained, the evaluating the target output result of the target model by using at least one evaluation model to obtain the target evaluation result for evaluating the accuracy of the target output result (i.e., the above Step S504) specifically includes:
after the target model is obtained and under the condition that the evaluation model is obtained by being trained based on the M training sample data and a pre-constructed evaluation data set, evaluating the target output result of the target model based on the evaluation model (i.e., the evaluation model meeting the Model Condition II) to obtain a first initial result and a second initial result corresponding to the evaluation model; and
obtaining the target evaluation result for evaluating the accuracy of the target output result based on the first initial result and the second initial result.
wherein the first initial result is used to measure the accuracy of the target output result of the target model; the second initial result is used to judge a probability that the target output result of the target model is an accurate value.

Therefore, the present disclosure provides a specific scheme for evaluating the target output result of the target model by using the evaluation model meeting the Model Condition II. This scheme can effectively evaluate the target model with a higher evaluation accuracy, which helps to lay a foundation for further improving the reasoning accuracy of the target model, and meanwhile, to lay a foundation for further enhancing the user experience.

Further, in an example, the first initial result is represented by a value: likelihood that the trained evaluation model outputs the target output result outputted from the target model; for instance, in a specific example, the likelihood that the trained evaluation model outputs the target output result outputted from the target model can be expressed by a formula: P(Y*|X, [symbol] (Θ′)),

wherein P(Y*|X, [symbol] (Θ′)) represents a conditional probability that the trained evaluation model (denoted as G (Θ′)) outputs the target output result Y* of the target model, that is, a conditional probability that the output result is Y* when X is input into the trained evaluation model, where Y* represents the target output result when X is input into the trained target model. For instance, in an example, X represents the m rounds of question-and-answer included in the training sample data and the candidate question set corresponding to the m^{th} round of question included in the training sample data.

And/or, in another example, the second initial result is represented by a value: likelihood that the trained evaluation model outputting the target output result outputted from the target model is accurate.

For instance, in a specific example, the likelihood that the trained evaluation model outputting the target output result outputted from the target model is accurate can be expressed by a formula: P(1|[X,Y*], [symbol] (Θ′)),

wherein P (1|[X,Y*], [symbol] (→′)) represents a probability that the outputted Y* is an accurate value after X is input into the trained evaluation model, where Y* represents the target output result when X is input into the trained target model. Here, in an example, X represents the m rounds of question-and-answer included in the training sample data and the candidate question set corresponding to the m^{th} round of question included in the training sample data.

Therefore, the present disclosure provides a specific scheme for evaluating the target output result of the target model by using the evaluation model meeting the Model Condition II, and the scheme has a higher accuracy of the evaluation result, is simple and convenient, and has strong interpretability, which helps to lay a foundation for further improving the reasoning accuracy of the target model, and meanwhile, to lay a foundation for further enhancing the user experience.

Further, in a specific example, under the condition that the evaluation model has both the question generation capability and the discrimination capability, that is, under the condition that the evaluation model meets the Model Condition II as described above, the target evaluation result may also be obtained by the following manner, that is, the obtaining the target evaluation result for evaluating the accuracy of the target output result based on the first initial result and the second initial result may specifically include:

performing weighting processing on the first initial result and the second initial result to obtain the target evaluation result for evaluating the accuracy of the target output result.

For instance, in an example, under the condition that the first initial result is P(Y*|X, [symbol] (Θ′)) and the second initial result is P(1|[X,Y*], [symbol] (Θ′)), then the target evaluation result can be specifically expressed as follows:

$$( 1 - α ) \times P ( {Y}^{*} \vert X , 𝒢 ( {Θ}^{′} ) ) + α \times P ( 1 \vert [ X , {Y}^{*} ] , 𝒢 ( {Θ}^{′} ) ) ,$$

wherein α can be an empirical value. At this point, the above equation represents a confidence of the trained evaluation model in the target output result of the trained target model.

Therefore, the present disclosure provides a specific scheme for evaluating the target output result of the target model by using the evaluation model meeting the Model Condition II, and the scheme has a higher accuracy of the evaluation result, is simple and convenient, and has strong interpretability, which helps to lay a foundation for further improving the reasoning accuracy of the target model, and meanwhile, to lay a foundation for further enhancing the user experience.

Model Condition III: under the condition that the parameter of the evaluation model is not adjustable, the parameter quantity of the adjustable parameters of the evaluation model is greater than the parameter quantity of the adjustable parameters of the target model.

Here, it should be noted that, in the present disclosure, a Black-box LLM (for example, GPT-4) with strong universality and larger parameter quantity of adjustable parameter may also be selected as the evaluation model. In this regard, although the Black-box LLM is untrained, because it has strong comprehension capability and rich knowledge, it still can be used as a fair judger. As such, it is possible to evaluate the accuracy of the target data result of the target model, so as to further improve the accuracy of the evaluation result, which helps to lay a foundation for further improving the reasoning accuracy of the target model, and meanwhile, to lay a foundation for further enhancing the user experience.

In a specific example of the present disclosure, under the condition that two or more evaluation models are used for evaluation, which are, for example, an evaluation model meeting Model Condition II and an evaluation model meeting Model Condition III, then an overall evaluation result for evaluating the accuracy of the target output result can be obtained based on the target evaluation result of each evaluation model. In this way, a problem of erroneous evaluation caused by a fact that the evaluation model is consistent with a training sample data distribution of the target model can be effectively remedied. Further, the M training sample data may be revised based on the overall evaluation result to obtain revised M training sample data. In such a way, for example, if the evaluation model meeting Model Condition II and the evaluation model meeting Model Condition III both consider that the target output result of a trained target model is correct, the training sample data corresponding to the target output result may be retained, otherwise, the training sample data with an incorrect target output result may be corrected, so as to improve the accuracy of the training sample data and further to increase data of the training sample data.

Further, in a specific example, the target model may be fine-tuned based on the revised M training sample data to obtain a revised target model, so as to further improve the reasoning accuracy of the target model and enhance user experience; and/or the evaluation model with the adjustable parameter may be fine-tuned based on the revised M training sample data to obtain a revised evaluation model. For example, the evaluation model to be trained is trained based on the revised M training sample data and a revised evaluation data set (the pre-constructed evaluation data set is revised based on the revised M training sample data), which helps to further improve the generation capability and the discrimination capability of the evaluation model, and to lay a foundation for further improving the accuracy of the evaluation result, improving the reasoning accuracy of the target model and improving the user experience.

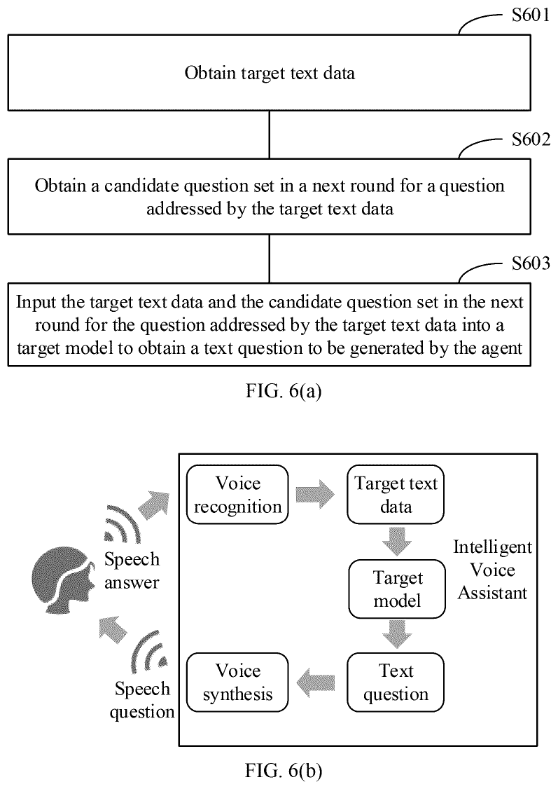

Specifically, FIG. 6(a) is a flow chart schematically illustrating a voice interaction method according to an embodiment of the present disclosure. The method is optionally applied to an electronic device such as a personal computer, a server, and a server cluster.

Further, the method includes at least some of the following contents, as shown in FIG. 6(a), including:

Step S601: target text data is obtained.

Here, the target text data is obtained based on a speech answer of an object in a previous round of question between the object and an agent.

Here, in a specific example, the target text data may be obtained by obtaining the speech answer of the object in the previous round of question and converting the speech answer of the object in the previous round of question into the target text data.

Therefore, the present disclosure provides a specific scheme of the dialog between the object and the agent, and the scheme is simple, convenient and efficient, has rich applicable scenes, and can be compatible with the existing scheme, which helps to lay a foundation for further enriching the user experience and improving the user experience.

Step S602: a candidate question set in a next round for a question addressed by the target text data is obtained.

Here, in a specific example, a next round of the candidate question set for the question addressed by the target text data is determined based on a finite state machine capable of representing a group of questions generated by the agent and a transfer condition for transferring from the current question to the next question; the transfer condition is related to the answer content of the object to reply to the current question. Here, the relevant contents of the finite state machine can be referred to the above description, and will not be described again. Therefore, since the scheme of the present disclosure provides the next round of candidate question set, the target model can perform reasoning within a specified range, such that an illusion problem of the target model during the generation process can be effectively avoided, and meanwhile the length of the generated problem can be reduced, thereby increasing the reasoning speed of the target model and enhancing the user experience.

Step S603: the target text data and the candidate question set in the next round for the question addressed by the target text data are input into a target model to obtain a text question to be generated by the agent, which is a text question for a question to be generated by the agent.

Here, in an example, the target model is trained by using the M training sample data; furthermore, it is trained by using the M training sample data and the training method.

Therefore, the scheme of the present disclosure can use the target model to reason a problem to be generated by the agent in the next round under the condition of giving the latest round of conversation, for example, based on the given understanding of the answer content in the latest round of conversation or on the understanding of the latest round of conversation, so as to meet the conversational requirement between the object and the agent, thereby enriching the user experience while improving the user experience.

Moreover, since the scheme of the present disclosure gives the next round of candidate question set during the reasoning process, the target model can perform reasoning within a specified range to realize the dialog management, and meanwhile, an illusion problem of the target model during the generation process can be effectively avoided and the length of the generated problem can be reduced, thereby increasing the reasoning speed of the target model and enhancing the user experience.

Further, in a specific example, after a text question is obtained, the obtained text question may be converted into a speech question and then the speech question is output, so that a free dialog between the object and the agent is realized. Moreover, the process is simple, convenient and efficient, has rich applicable scenes, and can be compatible with the existing scheme, thereby further enriching the user experience and further improving the user experience.

For example, FIG. 6(b) shows a schematic diagram of an inference scene. As shown in FIG. 6(b), a speech answer of a target object for the previous round of a speech question generated by the agent is obtained. A voice recognition module may convert the speech question into target text data and input a candidate question set in a next round corresponding to a question in the previous round into a target model. The target model generates a text question to be generated by the agent in the next round based on understanding of the question-and-answer in the previous round, and converts the text question generated by the target model into a speech question through a voice synthesis model and outputs the speech question, thereby realizing an intelligent dialogue process between the object and the agent.

The scheme of the disclosure will be further explained with reference to a specific example; compared to a modularization scheme (such as the modularization scheme shown in FIG. 1) in the existing art, the present disclosure proposes an intelligent question-asking scheme for the intelligent voice assistant based on a Large Language Model (LLM or called a large model), which can utilize the powerful language understanding capability, scheduling capability and generating capability of the large model to implement a dialog control in an end-to-end manner.

The scheme of the disclosure can replace a plurality of processing modules (e.g., NLU, DM and NLG) in the traditional voice assistant with a single processing module of the LLM, thereby effectively reducing the maintenance cost and service updating cost while effectively improving the accuracy of the output result and effectively enhancing the user experience.

Before introducing the solution of the present disclosure, for simplicity of description, the following concepts are defined:

Given that a question generated by the agent is denoted as Q, an answer content of the object is denoted as A, and interaction data (also called dialogue) between the agent and the object is denoted as C, then m rounds of question-and-answer (i.e., m rounds of dialogue) can be specifically expressed as:

C_{[1,m]}=(Q₁,A₁;Q₂,A₂; . . . ;Qₖ,Aₖ; . . . ;Qₘ,Aₘ),

wherein Qₖ represents a question generated by the agent in the k^{th} round of question-and-answer (or called the k^{th} round of dialog), and Aₖ represents an answer content of the object in the k^{th} round of question-and-answer.

Furthermore, an objective task of the present disclosure is as follows: given the m rounds of historical dialogues between the agent and the object, i.e., the m rounds of question-and-answer C_{[1,m]}, the LLM can predict a question Qₘ₊₁ to be generated by the agent in the next round (i.e., the (m+1)^{th} round) of dialogue.

The scheme of the present disclosure is specifically described in the following three aspects, which specifically include: Enhancement of LLM Training Data, Model Training and Realization of Dialog Management, and Continued Learning to Improve Effect of LLM.

### I. Enhancement of LLM Training Data

### (I) Preparation for Historical Dialogue Data

Training data is the basis for constructing the intelligent voice assistant, and in one example, historical dialogue data (i.e., historical interaction data) can be prepared as follows, specifically including:

(1) manually synthesizing dialog data between the agent and the object by a human.

(2) collecting a communication log between the agent and the object to obtain the dialog data.

### (II) Enhancement of Training Data

In an example, the historical dialogue data is segmented based on the position of the answer content of the object (for example, to obtain the m rounds of question-and-answer C_{[1,m]}), and the question of the agent in the next round (for example, Qₘ₊₁) can be used as label data. In this way, multiple segments of the historical dialogue data can be obtained through such segmentation.

Here, it should be noted that if the LLM is trained by directly using the obtained historical dialogue data between the agent and the object, for instance, by directly using the m rounds of question-and-answer C_{[1,m]} as input for the model to be trained and question Qₘ₊₁ of the agent in the (m+1)^{th} round as the label data to train the model to be trained, then it may lead the model to pay excessive attention to high-frequency dialogues while weakening its processing capacity of less common dialogues. This is because:

(1) A length of the dialog in the training data follows a long-tailed distribution, with shorter dialogs appearing more frequently and longer dialogs appearing less frequently.

(2) The reply (i.e., the answer content) of the object in the training data follows the long-tailed distribution because some replies are very frequent and some replies are less frequent.

Based on this, the solution of the disclosure focuses on boosting the training data of LLM by means of data enhancement to solve the above-mentioned problems, specifically including as the following.

First, the structure of the finite state machine is organized based on the collected historical dialogue data. For instance, in an example, a specific form of the finite state machine is defined as follows:

FSM={S,Σ,δ,s₀,F},

wherein S represents a set of states, which in this example specifically represents a set of all questions generated by the agent in the historical dialogue data, i.e., S={Qₖ}; Σ represents a set of all answer contents given by the object in the historical dialogue data, i.e., Σ={Aₖ}; δ: S×Σ→S represents a transfer function, which in this example specifically represents a question decided to be generated by the agent in the next round according to the answer content of the object based on the question generated by the agent in the previous round; for example, δᵢ: Qₘ×Aₘ→Qₘ₊₁; S₀ represents an initial state; F represents a set of final states, which is a subset of S. For a specific example of the state machine, reference can be made to FIG. 4(b) and will not be described herein.

Further, based on the finite state machine, data which can meet the following distribution requirements is selected from the prepared set of historical dialogue data to serve as the initial sample data after enhancement processing:

Condition 1: in all the initial sample data, the distribution of the replies (i.e., the answer contents) of the object in different state (i.e., different question) jumps complies with uniform distribution.

Condition 2: in all initial sample data, the distribution of different round numbers of dialog complies with uniform distribution.

That is, all the selected initial sample data, for example, the M initial sample data as described above, satisfy the above two conditions.

Specifically, in an example, the j^{th} initial sample data in the selected M initial samples can be denoted as xⱼ, and the j^{th} initial sample data x; includes the first m rounds of question-and-answer, the expression of which can be specified as:

xⱼ={δ₀,δ₁, . . . δᵢ, . . . δ_{|x}_{ⱼ}_{|}}

xⱼ˜pⱼ(x),∀δᵢ∈δ,

wherein the pⱼ(x) represents a data distribution of different initial training samples.

### II. Model Training and Realization of Dialog Management

The objective of this section is to implement dialog management using a large model, i.e., to enable the large model to accurately generate the appropriate dialogue content with given historical dialog.

Generally, the sample data after data enhancement processing (i.e., the initial sample data as mentioned above) can be directly used for training. For example, the m rounds of question-and-answer C_{[1,m]} is used as input and the question of the agent in (m+1)^{th} round as label data for model training. However, this training scheme may have the following problems:

In order to enable the reply of the intelligent voice assistant to meet the requirement of time delay, the LLM with high reasoning speed but small parameter quantity can be used, and the LLM with small parameter quantity is trained in a Self-training (SFT) mode. Some unsafe factors exist in the training process. For example, the training process is unstable and is easy to make mistakes when a long text is generated. Furthermore, all LLMs suffer from a drawback, namely an illusion problem, that the training easily produces some unsafe output, which seriously degrades the user experience.

In view of this, the present disclosure proposes a selective generation manner to solve the above-mentioned problems, which specifically includes:

Firstly, all possible problems of the agent in the next round are determined with reference to the finite state machine to construct a candidate set (i.e., the candidate question set). Here, the relevant description of the candidate set can be referred to the above description and will not be described herein again.

Second, the LLM selects the best option from the candidate set by analyzing the input historical dialog as the question to be generated for the next round. Therefore, compared to a complete question that is directly generated by the LLM, it is possible to effectively avoid the illusion problem during the generation process of the LLM while reducing the length of the generated question, thereby improving the reasoning speed of the LLM.

Finally, the solution of the present disclosure may also use Chain-of-Thought (CoT) technology to enhance the answer to LLM. Specifically, when constructing training sample data, this disclosure can leverage an intent expressed in the question-and-answer content in the latest round of dialog as reasoning and provide the agent with a suitable candidate set for the next round, thereby addressing the problem that the selective generation approach is hard to stably perform the SFT due to less supervisory signals.

In this example, the initial training set containing the initial sample data and the label data can be represented as follows and denoted as the initial training set D_{g}⁰:

$${D}_{g}^{0} = \{ ( {x}_{j} , {y}_{j} ) {\vert}_{j = 1}^{M} , {x}_{j} ∼ {p}_{j} ( x ) , {x}_{j} \to {y}_{j} \} ,$$

wherein M represents a total number of all training samples; xⱼ represents the m rounds of question-and-answer between the object and the agent in the j^{th} initial sample data, i.e., C_{[1,m]}; yⱼ represents the question to be generated by the agent for the next round in the j^{th} initial sample data, i.e., Qₘ₊₁. During the training process, the yⱼ serves as the label data.

Further, for a given data ((xⱼ, yⱼ)∈D_{g}⁰, an input to the model to be trained, such as an LLM to be trained, can be defined as:

X=prompt(xⱼ,Reply Options),

wherein Reply Options represents the question set for the next round corresponding to the m^{th} question in the j^{th} initial sample data, i.e., the candidate question set corresponding to the m^{th} question; prompt(⋅) represents a prompt function, configured to construct a segment of natural language statement by x; and the Reply Options (i.e., the above candidate set) for the understanding of the LLM to be trained.

Further, an output result (i.e., the above initial estimation result) of the model to be trained, such as the LLM to be trained, can be defined as:

[symbol]

_{Θ}(X),

wherein Θ represents an adjustable parameter of the LLM to be trained, and for example, specifically represents a vector composed of the adjustable parameter.

Further, the label data (also known as a genuine label) corresponding to the input X of the LLM can be defined as:

$$Y = \{ Chain - of - Thought , {y}_{j} corresponding option \} ,$$

wherein Chain-of-Thought represents a user intention in the previous round, and for example, represents the understanding of the answer content of the object in the previous round, such as the understanding of the answer content in the m^{th} round, or may also represent the understanding of the question-and-answer in the previous round, such as the understanding of the question and the answer content in the m^{th} round.

Based on this, the training sample data can be specifically represented as (X, Y).

Further, an objective of training may be embodied as minimizing a distance between the output result of the LLM and the genuine label:

argmin [symbol] ( [symbol] _{Θ}(X)·Y).

Further, during the reasoning phase, the trained LLM can then reason about the question to be generated by the agent for the next round based on the understanding of the answer content in the latest round of dialog or the understanding of the latest round of dialog.

### III. Model Reasoning

Here, it should be noted that, during the reasoning phase: the answer content in the latest round of dialog and the candidate question set corresponding to the question in the latest round of dialog can be sorted into a prompt question and then input into the trained large model, so that the large model can deduce the question to be generated by the agent in the next round based on the understanding of the answer content in the latest round of dialog or the understanding of the last latest of dialog.

### IV. Continued Learning to Improve Effect of LLM

In order to further improve the effect of the trained LLM, the present disclosure further proposes a collaborative iteration scheme.

First, it should be noted that the scheme of the present disclosure categorizes large model into three types: LLM-S, LLM-L and Black-box LLM. Here, LLM-S and LLM-L both represent large models that can be fine-tuned, where LLM-S represents a large model with a small parameter quantity of adjustable parameters (e.g., a parameter quantity less than 2 billion), and LLM-L represents a large model with a large parameter quantity of adjustable parameters (e.g., a parameter quantity greater than 2 billion). Here, in an example, LLM-S and LLM-L can has similar model structures, differing primarily in their parameter quantities. It can be understood that LLM-L performs better than LLM-S due to its larger parameter quantity of the adjustable parameters, although it may have a slower reasoning speed. While the Black-box LLM is a closed-source model with an ultra-large parameter quantity, such as GPT-4 and similar models, this type of model possesses a very high capacity, rich world knowledge, but does not support fine-tuning of the parameters.

Secondly, it should be noted that, in an intelligent voice assistant scenario, in order to meet the requirement of low delay, the scheme of the present disclosure deploys the LLM-S with a smaller parameter quantity as a bottom model (that is, the model to be trained is the LLM-S); moreover, in order to further improve the effect of the trained LLM-S, the scheme of the present disclosure uses the LLM-L and the Black-box LLM in conjunction with a small amount of human feedback to identify a short board of an online model (the trained LLM-S, i.e., the target model as mentioned above) in a continuous iteration manner, and corrects the short board to assist the online LLM-S(i.e., the trained LLM-S) in improving its effect.

Specifically, in the scheme of the present disclosure, the continued learning process includes two core steps, which are a data promotion step and a reasoning promotion step, respectively. For example, the training sample data can be optimized through the continued learning process, so as to further promote the data quality of the training sample data and achieve data promotion; on the other hand, the training sample data with the quality promoted is used to perform the fine-tuning on the trained model (for example, the trained LLM-S, i.e., the target model as mentioned above) again, so as to further improve the reasoning effect. In addition, the training sample data with the quality promoted can also be used to perform the fine-tuning on the evaluation model again, so as to further improve the evaluation effect of the evaluation model.

Here, before introducing the continued learning process, the following description is made:
Firstly, in the continued learning process, the model obtained by training the LLM-S by adopting the above enhanced training sample data and the above training mode is optimized; Here, the trained LLM-S can be denoted as [symbol] *_{Θ}.

Secondly, in the continued learning process, the following candidate data set in the data promotion phase is defined. For example, in the data promotion phase, a candidate data set used in the t^{th} iteration is defined as follows:

$${D}_{g}^{t} = \{ ( {x}_{j} , {y}_{j}^{′} ) \vert {}_{j = 1}^{M} \vert {x}_{j} ∼ {p}_{j} ( x ) , {y}_{j}^{′} = {ℱ}_{Θ}^{* t} ( {x}_{j} ) \} ,$$

where xⱼ represents the above j^{th} initial sample data, containing the first m rounds of question-and-answer; y′ⱼ represents the output result of inputting x; into the trained LLM-S, i.e., the output result of [symbol] *_{Θ}. In other words, the input data used in the data promotion step includes the initial sample data, and the label data is the output result of the trained model, i.e., the output result of [symbol] *_{Θ}. Thus, an evaluator, such as an evaluation model, is used to evaluate the accuracy of the output result of [symbol] *_{Θ}.

It can be understood that the input data used in the data promotion step can also include the next round of the question set corresponding to the latest round of question in the initial sample data. For instance, under the condition that the initial sample data includes the first m rounds of question-and-answer C_{[1,m]}, the input data used in the data promotion step also includes the next round of the question set corresponding to the m^{th} question. In other words, the continued learning phase follows the original processing pattern of the model, thereby achieving the improvement on the performance of the model without altering the original processing pattern.

Thirdly, before the continued learning process, such as before the data promotion process, an evaluator, such as an evaluation model, needs to be constructed in advance to evaluate the output result of the trained LLM-S. For example, the accuracy of the above candidate data set D_{g}^{t} is evaluated. If problematic data is discovered, it can be revised by human, thereby further revising the enhanced training sample data to achieve further data enhancement of the training sample data. Here, the revised training sample data set can be denoted as D̅_{g}^{t}:

$${\overline{D}}_{g}^{t} = \{ ( {\overline{x}}_{j} , {\overline{y}}_{j} ) \vert {}_{j = 1}^{M} \vert {\overline{x}}_{j} ∼ {p}_{j} ( x ) \} ,$$

wherein x̅ⱼ represents the revised j^{th} initial sample data xⱼ, and y̅ⱼ represents the revised yⱼ, i.e., the revised Q_{m+1.}

Here, it should be noted that, if the evaluation model constructed in advance is a parameter-adjustable model, the evaluation model used in the data promotion step is a trained model.

Fourthly, during a strategy promotion phase, the scheme of the present disclosure can further enhance the generation capability of the trained LLM-S and the evaluation capability of the evaluation model based on the revised training sample data set D̅_{g}^{t}.

Thus, the scheme of the present disclosure can realize continuous improvement on the online LLM-S capacity by alternately executing the data promotion step and the strategy promotion step.

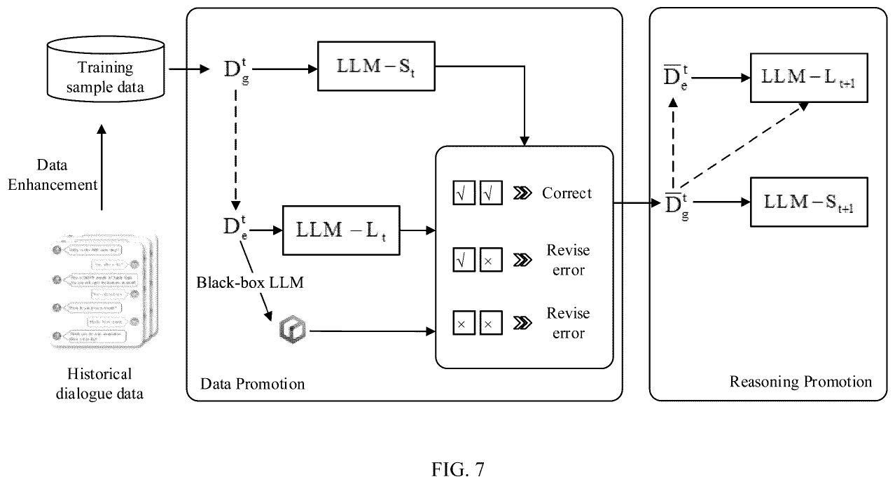

The data promotion step and the reasoning promotion step will be described in detail below with reference to FIG. 7:

### (I) Data Promotion Stage

In the data promotion stage, customization of effective evaluator is crucial. Therefore, the scheme of the present disclosure selects the LLM-L with adjustable parameters and large parameter quantity as an evaluation model, and meanwhile, also selects the universal Black-box LLM as an evaluation model. Evaluation results of the two models are synthesized to optimize training sample data so as to realize the data promotion.

Here, it should be noted that, before the trained LLM-S is evaluated by using the LLM-L, the LLM-L needs to be trained in advance. For example, the LLM-L is trained by using the same training sample data (for example, the above-mentioned M training sample data) as the LLM-S, so that the LLM-L knows the knowledge in the related arts and becomes an expert. At this time, with the larger parameter quantity, the LLM-L can better understand a specific service scenario.

In addition, considering that training sample data used by both LLM-L and LLM-S are overlapping, errors within the training data can be incorporated into the models. To address this, a universal Black-box LLM can be further introduced as an evaluation model to ensure impartial evaluation. While the evaluation model of the Black-box LLM cannot be directly fine-tuned, it possesses strong general recognition capability and can provide objective evaluations, thus effectively mitigating the problem of erroneous evaluation resulting from the identical distribution of training sample data between LLM-L and LLM-S.

### (1) Evaluation Model-LLM-L

It can be understood that, given the same training sample data, the LLM-L is expected to outperform the LLM-S in terms of performance. Therefore, the LLM-L will possess a strong generation capability after fine-tuning the parameters of the LLM-L with the training sample data used for training the LLM-S. This means that, after the LLM-L and the LLM-S are trained with the same training sample data, the trained LLM-L is more likely to produce correct results than the trained LLM-S when given the same training sample data.

Here, the trained LLM-L can be denoted as [symbol] (Θ′), where Θ′ represents the adjustable parameters of LLM-L, which can specifically refer to the vector of adjustable parameters in the trained LLM-L.

Further, the trained LLM-L (i.e., [symbol] (Θ′)) can be used to evaluate the accuracy of the output result from the trained LLM-S, for example, by generating likelihood of the output result from the trained LLM-S using the trained LLM-L to measure the accuracy of the output result from the trained LLM-S. The likelihood of the output result from the trained LLM-S generated by using the trained LLM-L (denoted as P(Y*|X,G(Θ′)), corresponding to the above first initial result, can be expressed as follows:

$$P ( {Y}^{*} \vert X , 𝒢 ( {Θ}^{′} ) ) = {\prod }_{i = 1}^{\vert {Y}^{*} \vert} {g ( {Y}_{i}^{*} \vert [ X , {Y}_{1 : i - i}^{*} ] )}^{\frac{1}{\vert {Y}^{*} \vert}} ,$$

wherein P(Y*|X, [symbol] (Θ′)) represents a conditional probability that the trained LLM-L (i.e., [symbol] (Θ′)) outputs the output result of the trained LLM-S, that is, a probability that the output result is Y* when X=prompt(xⱼ, Reply Options) is input into the trained LLM-L, where Y* represents the output result after X=prompt(xⱼ, Reply Options) is input into the trained LLM-S.

Further, Y*ᵢ represents the i^{th} token in the output result Y*; Y*_{1:i-i}=(Y*₁, . . . , Y*ᵢ₋₁).

g(v|X) represents a probability that the output is v (referring to a token) after X is input into the trained LLM-L, and its calculation formula is as follows:

$$g ( v \vert X ) = \frac{exp ( \overline{g} ( v \vert X ) )}{{\sum }_{{v}^{′} ∈ V} exp ( \overline{g} ( {v}^{′} \vert X ) )} ,$$

wherein g̅(v|X) represents the logits of outputting v when given the input X; V represents the predefined vocabulary set; g̅(v|X) is equivalent to the normalized version of g̅(v|X).

In addition, in order to further improve the evaluation capability of the evaluation model LLM-L, the evaluation model LLM-L can be trained from the judgment perspective, thereby further improving the evaluation capability of the LLM-L.

Specifically, for each data (xⱼ, y′ⱼ)∈D_{g}^{t}, its formalized representation in a form of positive sample (X, Y) can simultaneously generate a question different from y′ to construct a form of negative sample in (X, Ŷ), thereby obtaining a new data set (also called an evaluation data set) Dₑ^{t}, which is specifically expressed as follows:

Dₑ^{t}={(X,Y),1),((X,Ŷ),0)|(xⱼ,y′ⱼ)∈D_{g}^{t}}.

Further, an evaluation prompt question is obtained based on (X, Y) and (X, Ŷ) included in the evaluation data set, and the obtained evaluation prompt question is input into the LLM-L to train the LLM-L by using the corresponding label data (for example, the label data for the positive sample is 1, and the label data for the negative sample is 0), so as to perform evaluation a task and obtain the trained LLM-L.

After fine-tuning the parameter of the LLM-L using the evaluation data set and the training sample data of the LLM-S, the trained LLM-S is obtained. At this point, the trained LLM-S not only has evaluation capability but also discriminative capability. For example, based on the trained LLM-S, the likelihood that the output Y* is correct given the input X (denoted as P(1|[X, Y*], [symbol] (Θ′)), corresponding to the above second initial result), which is defined as follows:

$$P ( 1 \vert [ X , {Y}^{*} ] , 𝒢 ( {Θ}^{′} ) ) = \frac{exp ( \overline{g} ( 1 \vert {X}_{e} ) )}{{\sum }_{l ∈ \{ 0 , 1 \}} exp ( \overline{g} ( l \vert {X}_{e} ) )} ,$$

wherein P(1|[X, Y*], [symbol] (Θ′)) represents the probability that the output Y* is a correct value when X is input into the trained LLM-S, where Y* represents the output result after X is input into the trained LLM-S.

Further, Xₑ=promptₑ(X, Y*) represents the prompt question composed of X and Y*; g̅(l|Xₑ) represents the logits that the output Y* is l (0 or 1) after X is input into the trained LLM-L.

It should be noted that in an example, the parameter of LLM-L can be fine-tuned by using the training sample data for training the LLM-S. At this point, the trained LLM-L can be used to evaluate the accuracy of the output result of the trained LLM-S, for example, the above P(Y*|X, [symbol] (Θ′)) can be used to evaluate the accuracy of the output result of the trained LLM-S, so that the training sample data can be optimized based on the accuracy.

Alternatively, in another example, both the training sample data for training LLM-S and the evaluation data set Dₑ^{t} as constructed above can be used to fine-tune LLM-L, thereby further improving the accuracy of the evaluation result.

Further, in an example, the evaluation results from above two perspectives can be combined to obtain the confidence of the trained LLM-L in the output result of the trained LLM-S:

$$c = ( 1 - α ) \times P ( {Y}^{*} \vert X , 𝒢 ( {Θ}^{′} ) ) + α \times P ( 1 \vert [ X , {Y}^{*} ] , 𝒢 ( {Θ}^{′} ) ) ,$$

wherein α is an empirical value; or a hyperparameter, the specific value of which can be determined in an iterative manner, for example, if a exceeds a preset threshold, then the output of the trained LLM-S can be considered correct.

### (2) Evaluation Model-Black-Box LLM

Black-box LLM can be used as an impartial evaluator, which is not influenced by the current training data distribution. For example, the output result of trained LLM-S can be evaluated by a designed prompt.

### (3) Collaborative Voting Mechanism

For each data in D_{g}^{t}, the evaluation results from the trained LLM-L and the Black-box LLM can be integrated for collaborative evaluation. For example, if both the trained LLM-L and the Black-box LLM consider the output of the trained LLM-S to be correct, then the data is retained; otherwise, it can be reviewed and revised manually. Through this revision step, a revised data set D̅_{g}^{t} can be obtained.

### (II) Strategy Promotion Stage

In this phase, the revised data set D̅_{g}^{t} can be used to further fine-tune the trained LLM-S and the trained evaluation model. For example, the revised data set D̅_{g}^{t} is used to fine-tune the trained LLM-S to obtain a revised LLM-S. As for the trained LLM-L, the revised data set D̅_{g}^{t} can be used to optimize the evaluation data set, to obtain an optimized evaluation data set D̅ₑ^{t}. The optimized data set D̅_{g}^{t} and the optimized evaluation data set D̅_{g}^{t} can then be used to continue fine-tuning the trained LLM-L, thereby further improving its generation capability and discrimination capability. Meanwhile the prompt can be updated to enhance the evaluation capability of the Black-box LLM.

Based on this, the loop iteration scheme according to the present disclosure can ensure that the effect of the on-line LLM-S as a whole is continuously improved, and moreover, the performance of the evaluation model as used is also continuously improved.

It should be noted that the scheme of the present disclosure can be applied to the field of intelligent voice assistant. Based on the scheme of the present disclosure, an intelligent voice assistant based on LLM can be built from scratch, and AI (Artificial Intelligence) nativization based on the LLM can be realized on the basis of the pre-existing modularized voice assistant. In addition, it should be noted that the scheme of the present disclosure is not limited to the scenario of the intelligent voice assistant, and may also be applied to other fields. In other words, the scheme of the present disclosure has excellent versatility and may be adapted to other application scenarios.

After the method according to the scheme of the disclosure is applied to projects involving the acquisition of map POI attributes, the success rate of POI attribute retrieval can be improved by 4 percent.

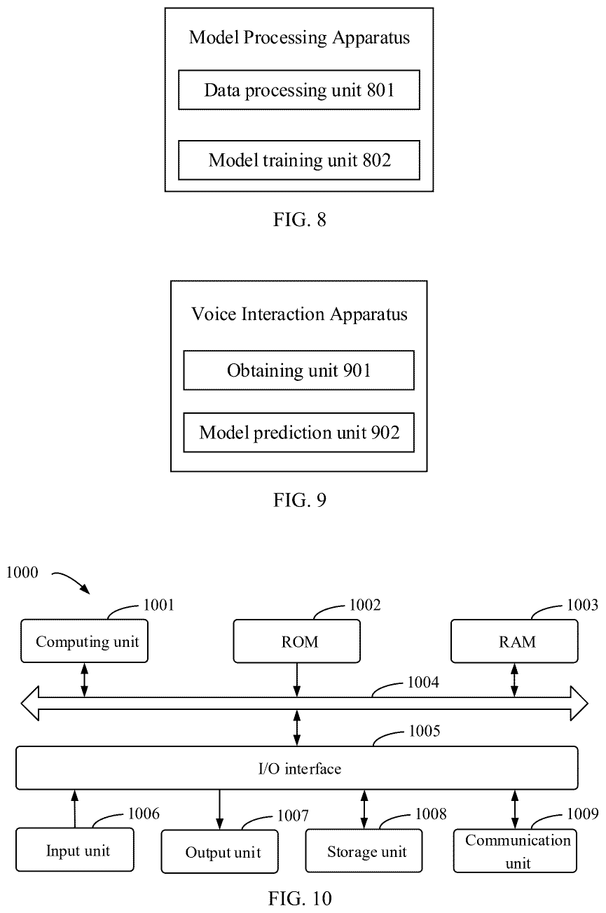

The present disclosure further provides a model processing apparatus, as shown in FIG. 8, including:
a data processing unit 801, configured to obtain a candidate question set of each initial sample data in M initial sample data, wherein the initial sample data includes m rounds of question-and-answer between an object and an agent, the candidate question set of the initial sample data includes a next round of question set corresponding to the m^{th} round of question in the m rounds of question-and-answer, and M and m are both positive integers greater than or equal to 1; and obtain M training sample data based on the M initial sample data, the candidate question set of each initial sample data and label data of each initial sample data, wherein the label data of the initial sample data includes a target question to be generated by the agent in the (m+1)^{th} round; and
a model training unit 802, configured to train a model to be trained by using the M training sample data to obtain a target model capable of predicting a question to be generated by the agent in a next round based on historical questions and answers.

In a specific example of the present disclosure, the model training unit is specifically configured to:
input the m rounds of question-and-answer included in the training sample data and the candidate question set corresponding to the m^{th} round of question included in the training sample data into the model to be trained to obtain an initial estimation result, wherein the initial estimation result represents a predicted question to be generated by the agent in the (m+1)^{th} round;
obtain a loss value of a loss function based on the initial estimation result and the target question to be generated by the agent in the (m+1)^{th} round included in the label data in the training sample data, wherein the loss function represents a distance between the predicted question and the target question; and
adjust at least part of adjustable parameters in the model to be trained based on the loss value of the loss function to obtain the target model by training.

In a specific example of the present disclosure, the model training unit is specifically configured to:
obtain a target cue word question based on the m rounds of question-and-answer included in the training sample data and the candidate question set corresponding to the m^{th} round of question included in the training sample data; and
input the target cue word question into the model to be trained.

In a specific example of the present disclosure, the data processing unit is further configured to:
obtain the M initial sample data meeting at least one of the following conditions based on a determined finite state machine where:
in the M initial sample data, a distribution of the number of initial sample data with different lengths meets a first distribution requirement, and a length of the initial sample data is determined based on a finite state machine and represents the number of rounds of question-and-answer;
in the M initial sample data, a distribution of an answer content of transferring from a previous question to a next question meets a second distribution requirement,
wherein the finite state machine represents a group of questions generated by the agent and a transfer condition for transferring from a current question to a next question; the transfer condition is related to the answer content of the object to reply to the current question.

In a specific example of the present disclosure, the data processing unit is further configured to:
determine the finite state machine based on N historical interaction data between the object and the agent, wherein historical interaction data in the N historical interaction data includes m rounds of question-and-answer between the object and the agent and a question to be generated by the agent in the (m+1)^{th} round, and N is a positive integer greater than or equal to 1; and
select the M initial sample data meeting at least one of the following conditions from the N historical interaction data based on the determined finite state machine.

In a specific example of the present disclosure, the model processing apparatus further includes a model evaluation unit, wherein the model evaluation unit is configured to:
after the target model is obtained, evaluate a target output result of the target model by using at least one evaluation model to obtain a target evaluation result for evaluating an accuracy of the target output result,
wherein an evaluation model in the at least one evaluation model meets at least one of the following conditions where:
under the condition that a parameter of the evaluation model is adjustable, a parameter quantity of adjustable parameters of the evaluation model is greater than a parameter quantity of adjustable parameters of the target model, and the evaluation model is obtained by being trained based on the M training sample data;
under the condition that the parameter of the evaluation model is adjustable, the parameter quantity of the adjustable parameters of the evaluation model is greater than the parameter quantity of the adjustable parameters of the target model, and the evaluation model is obtained by being trained based on the M training sample data and a pre-constructed evaluation data set; and
under the condition that the parameter of the evaluation model is not adjustable, the parameter quantity of the adjustable parameters of the evaluation model is greater than the parameter quantity of the adjustable parameters of the target model.

In a specific example of the present disclosure, the pre-constructed evaluation data set includes a plurality of positive sample data and a plurality of negative sample data constructed based on the plurality of positive sample data,
wherein positive sample data in the plurality of positive sample data is obtained based on the initial sample data in the M initial sample data, and includes m rounds of question-and-answer and a genuine question generated by the target model in the (m+1)^{th} round; and
negative sample data constructed based on the positive sample data includes m rounds of question-and-answer and a constructed fake question in the (m+1)^{th} round.

In a specific example of the present disclosure, the model evaluation unit is specifically configured to:
after the target model is obtained and under the condition that the evaluation model is obtained by being trained based on the M training sample data, evaluate the target output result of the target model based on the evaluation model to obtain an initial evaluation result corresponding to the evaluation model, wherein the initial evaluation result for the evaluation model is used to measure the accuracy of the target output result of the target model.

In a specific example of the present disclosure, the initial evaluation result corresponding to the evaluation model is represented by a value: likelihood that the trained evaluation model outputs the target output result outputted from the target model.

In a specific example of the present disclosure, the model evaluation unit is specifically configured to:
after the target model is obtained and under the condition that the evaluation model is obtained by being trained based on the M training sample data and the pre-constructed evaluation data set, evaluate the target output result of the target model based on the evaluation model to obtain a first initial result and a second initial result corresponding to the evaluation model; and
obtain the target evaluation result for evaluating the accuracy of the target output result based on the first initial result and the second initial result,
wherein the first initial result is used to measure the accuracy of the target output result of the target model; the second initial result is used to judge a probability that the target output result of the target model is an accurate value.

In a specific example of the present disclosure, the first initial result is represented by a value: likelihood that the trained evaluation model outputs the target output result outputted from the target model;
and/or, the second initial result is represented by a value: likelihood that the trained evaluation model outputting the target output result outputted from the target model is accurate.

In a specific example of the present disclosure, the model evaluation unit is specifically configured to:
perform weighting processing on the first initial result and the second initial result to obtain the target evaluation result for evaluating the accuracy of the target output result.

In a specific example of the present disclosure,
the model evaluation unit is further configured to, under the condition that two or more evaluation models are used for evaluation, obtain an overall evaluation result for evaluating the accuracy of the target output result based on the target evaluation result of each evaluation model; and
the data processing unit is further configured to revise the M training sample data based on the overall evaluation result to obtain revised M training sample data.

In a specific example of the present disclosure, the model training unit is further configured to:
fine-tune the target model based on the revised M training sample data to obtain a revised target model;
and/or
fine-tune the evaluation model with the adjustable parameter based on the revised M training sample data to obtain a revised evaluation model.

For a description of specific functions and examples of each unit of the model processing apparatus in the embodiment of the present disclosure, reference may be made to the related description of the corresponding steps in the foregoing method embodiments, and details thereof are not repeated herein.

The present disclosure further provides a voice interaction apparatus, as shown in FIG. 9, including:
an obtaining unit 901, configured to obtain target text data, wherein the target text data is obtained based on a speech answer of an object in a previous round of question between the object and an agent, and to obtain a candidate question set in a next round for a question addressed by the target text data; and
a model prediction unit 902, configured to input the target text data and the candidate question set in the next round for the question addressed by the target text data into a target model to obtain a text question to be generated by the agent.

In a specific example of the present disclosure, the voice interaction apparatus further includes: a voice synthesis unit, wherein the voice synthesis unit is configured to:
convert the obtained text question into a speech question and output the speech question.

In a specific example of the present disclosure, the voice interaction apparatus further includes: a voice recognition unit, wherein the voice recognition unit is configured to:
obtain a speech answer of the object for the previous round of question; and
convert the speech answer of the object for the previous round of question into the target text data.

In the voice interaction apparatus, the candidate question set in the next round for the question addressed by the target text data is determined based on a finite state machine capable of representing a group of questions generated by the agent and a transfer condition for transferring from a current question to the next question; the transfer condition is related to an answer content of the object to reply to the current question.

For a description of specific functions and examples of each unit of the voice interaction apparatus in the embodiments of the present disclosure, reference may be made to the related description of the corresponding steps in the foregoing method embodiments, and details thereof are not repeated herein.

In the technical solution of the present disclosure, the acquisition, storage and application of the user's personal information involved are all in compliance with the provisions of relevant laws and regulations, and do not violate public order and good customs.

According to the embodiments of the present disclosure, the present disclosure also provides an electronic device, a readable storage medium and a computer program product.

FIG. 10 shows a schematic block diagram of an exemplary electronic device 1000 that may be used to implement the embodiments of the present disclosure. The electronic device is intended to represent various forms of digital computers, such as a laptop, a desktop, a workstation, a personal digital assistant, a server, a blade server, a mainframe computer, and other suitable computers. The electronic device may also represent various forms of mobile devices, such as a personal digital assistant, a cellular phone, a smart phone, a wearable device and other similar computing devices. The components shown herein, their connections and relationships, and their functions are merely examples, and are not intended to limit the implementation of the present disclosure described and/or required herein.

As shown in FIG. 10, the device 1000 includes a computing unit 1001 that may perform various appropriate actions and processes according to a computer program stored in a Read-Only Memory (ROM) 1002 or a computer program loaded from a storage unit 1008 into a Random Access Memory (RAM) 1003. Various programs and data required for an operation of device 1000 may also be stored in the RAM 1003. The computing unit 1001, the ROM 1002 and the RAM 1003 are connected to each other through a bus 1004. The input/output (I/O) interface 1005 is also connected to the bus 1004.

A plurality of components in the device 1000 are connected to the I/O interface 1005, and include an input unit 1006 such as a keyboard, a mouse, or the like; an output unit 1007 such as various types of displays, speakers, or the like; the storage unit 1008 such as a magnetic disk, an optical disk, or the like; and a communication unit 1009 such as a network card, a modem, a wireless communication transceiver, or the like. The communication unit 1009 allows the device 1000 to exchange information/data with other devices through a computer network such as the Internet and/or various telecommunication networks.

The computing unit 1001 may be various general-purpose and/or special-purpose processing components with processing and computing capabilities. Some examples of the computing unit 1001 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 1001 performs various methods and processing described above, such as the above model processing method or voice interaction method. For example, in some implementations, the above model processing method or voice interaction method may be implemented as a computer software program tangibly contained in a computer-readable medium, such as the storage unit 1008. In some implementations, a part or all of the computer program may be loaded and/or installed on the device 1000 via the ROM 1002 and/or the communication unit 1009. When the computer program is loaded into RAM 1003 and executed by the computing unit 1001, one or more steps of the model processing method or voice interaction method described above may be performed. Alternatively, in other implementations, the computing unit 1001 may be configured to perform the above model processing method or voice interaction method by any other suitable means (e.g., by means of firmware).

Various implements of the system and technologies described above herein may be implemented in a digital electronic circuit system, an integrated circuit system, a Field Programmable Gate Array (FPGA), an Application Specific Integrated Circuit (ASIC), Application Specific Standard Parts (ASSP), a System on Chip (SOC), a Complex Programmable Logic Device (CPLD), a computer hardware, firmware, software, and/or a combination thereof. These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, which enables the program code, when executed by the processor or controller, to cause the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, a Random Access Memory (RAM), a Read-Only Memory (ROM), an Erasable Programmable Read-Only Memory (EPROM or a flash memory), an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a display apparatus (e.g., a cathode ray tube (CRT) or a Liquid Crystal Display (LCD) monitor) for displaying information to the user; and a keyboard and a pointing device (e.g., a mouse or a trackball) through which the user may provide input to the computer. Other types of devices may also be used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system (which serves as, for example, a data server) including a back-end component, or in a computing system (which serves as, for example, an application server) including a middleware, or in a computing system including a front-end component (e.g., a user computer with a graphical user interface or web browser through which the user may interact with the implementation of the system and technologies described herein), or in a computing system including any combination of the back-end component, the middleware component, or the front-end component. The components of the system may be connected to each other through any form or kind of digital data communication (e.g., a communication network). Examples of the communication network include a Local Area Network (LAN), a Wide Area Network (WAN), and the Internet.

A computer system may include a client and a server. The client and server are generally far away from each other and usually interact with each other through a communication network. A relationship between the client and the server is generated by computer programs running on corresponding computers and having a client-server relationship with each other. The server may be a cloud server, a distributed system server, or a blockchain server.

It should be understood that, the steps may be reordered, added or removed by using the various forms of the flows described above. For example, the steps recorded in the present disclosure can be performed in parallel, in sequence, or in different orders, as long as a desired result of the technical scheme disclosed in the present disclosure can be realized, which is not limited herein.

The foregoing specific implementations do not constitute a limitation on the protection scope of the present disclosure. Those having ordinary skill in the art should understand that, various modifications, combinations, sub-combinations and substitutions may be made according to a design requirement and other factors. Any modification, equivalent replacement, improvement or the like made within the spirit and principle of the present disclosure shall be included in the protection scope of the present disclosure.

What is claimed is:

1. A model processing method, comprising:
obtaining a candidate question set of each initial sample data in M initial sample data, wherein the initial sample data includes m rounds of question-and-answer between an object and an agent, the candidate question set of the initial sample data includes a next round of question set corresponding to the m^{th} round of question in the m rounds of question-and-answer, and M and m are both positive integers greater than or equal to 1;
obtaining M training sample data based on the M initial sample data, the candidate question set of each initial sample data and label data of each initial sample data, wherein the label data of the initial sample data includes a target question to be generated by the agent in the (m+1)^{th} round; and
training a model to be trained by using the M training sample data to obtain a target model capable of predicting a question to be generated by the agent in a next round based on historical questions and answers.

2. The method of claim 1, wherein the training the model to be trained by using the M training sample data to obtain a target model capable of predicting a question to be generated by the agent in a next round based on historical questions and answers comprises:
inputting the m rounds of question-and-answer included in the training sample data and the candidate question set corresponding to the m^{th} round of question included in the training sample data into the model to be trained to obtain an initial estimation result, wherein the initial estimation result represents a predicted question to be generated by the agent in the (m+1)^{th} round;
obtaining a loss value of a loss function based on the initial estimation result and the target question to be generated by the agent in the (m+1)^{th} round included in the label data in the training sample data, wherein the loss function represents a distance between the predicted question and the target question; and
adjusting at least part of adjustable parameters in the model to be trained based on the loss value of the loss function to obtain the target model by training.

3. The method of claim 2, wherein the inputting the m rounds of question-and-answer included in the training sample data and the candidate question set corresponding to the m^{th} round of question included in the training sample data into the model to be trained comprises:
obtaining a target cue word question based on the m rounds of question-and-answer included in the training sample data and the candidate question set corresponding to the m^{th} round of question included in the training sample data; and
inputting the target cue word question into the model to be trained.

4. The method of claim 1, further comprising:
obtaining the M initial sample data meeting at least one of the following conditions based on a determined finite state machine where:
in the M initial sample data, a distribution of the number of initial sample data with different lengths meets a first distribution requirement, and a length of the initial sample data is determined based on a finite state machine and represents the number of rounds of question-and-answer;
in the M initial sample data, a distribution of an answer content of transferring from a previous question to a next question meets a second distribution requirement,
wherein the finite state machine represents a group of questions generated by the agent and a transfer condition for transferring from a current question to the next question; the transfer condition is related to the answer content of the object to reply to the current question.

5. The method of claim 4, further comprising:
determining the finite state machine based on N historical interaction data between the object and the agent, wherein historical interaction data in the N historical interaction data includes m rounds of question-and-answer between the object and the agent and a question to be generated by the agent in the (m+1)^{th} round, and N is a positive integer greater than or equal to 1,
wherein the obtaining the M initial sample data meeting at least one of the following conditions based on the determined finite state machine comprises:
selecting the M initial sample data meeting at least one of the following conditions from the N historical interaction data based on the determined finite state machine.

6. The method of claim 1, further comprising:
evaluating, after the target model is obtained, a target output result of the target model by using at least one evaluation model to obtain a target evaluation result for evaluating an accuracy of the target output result,
wherein an evaluation model in the at least one evaluation model meets at least one of the following conditions where:
under the condition that a parameter of the evaluation model is adjustable, a parameter quantity of adjustable parameters of the evaluation model is greater than a parameter quantity of adjustable parameters of the target model, and the evaluation model is obtained by being trained based on the M training sample data;
under the condition that the parameter of the evaluation model is adjustable, the parameter quantity of the adjustable parameters of the evaluation model is greater than the parameter quantity of the adjustable parameters of the target model, and the evaluation model is obtained by being trained based on the M training sample data and a pre-constructed evaluation data set; and
under the condition that the parameter of the evaluation model is not adjustable, the parameter quantity of the adjustable parameters of the evaluation model is greater than the parameter quantity of the adjustable parameters of the target model.

7. The method of claim 6, wherein the pre-constructed evaluation data set includes a plurality of positive sample data and a plurality of negative sample data constructed based on the plurality of positive sample data;
wherein positive sample data in the plurality of positive sample data is obtained based on the initial sample data in the M initial sample data, and includes m rounds of question-and-answer and a genuine question generated by the target model in the (m+1)^{th} round; and
negative sample data constructed based on the positive sample data includes m rounds of question-and-answer and a constructed fake question in the (m+1)^{th} round.

8. The method of claim 6, wherein the evaluating, after the target model is obtained, the target output result of the target model by using at least one evaluation model to obtain the target evaluation result for evaluating the accuracy of the target output result comprises:
after the target model is obtained and under the condition that the evaluation model is obtained by being trained based on the M training sample data, evaluating the target output result of the target model based on the evaluation model to obtain an initial evaluation result corresponding to the evaluation model, wherein the initial evaluation result for the evaluation model is used to measure the accuracy of the target output result of the target model;
wherein the initial evaluation result corresponding to the evaluation model is represented by a value: likelihood that the trained evaluation model outputs the target output result outputted from the target model.

9. The method of claim 7, wherein the evaluating, after the target model is obtained, the target output result of the target model by using at least one evaluation model to obtain the target evaluation result for evaluating the accuracy of the target output result comprises:
after the target model is obtained and under the condition that the evaluation model is obtained by being trained based on the M training sample data and the pre-constructed evaluation data set, evaluating the target output result of the target model based on the evaluation model to obtain a first initial result and a second initial result corresponding to the evaluation model; and
obtaining the target evaluation result for evaluating the accuracy of the target output result based on the first initial result and the second initial result,
wherein the first initial result is used to measure the accuracy of the target output result of the target model; the second initial result is used to judge a probability that the target output result of the target model is an accurate value.

10. The method of claim 9, wherein the first initial result is represented by a value: likelihood that the trained evaluation model outputs the target output result outputted from the target model;
and/or, the second initial result is represented by a value: likelihood that the trained evaluation model outputting the target output result outputted from the target model is accurate.

11. The method of claim 9, wherein the obtaining the target evaluation result for evaluating the accuracy of the target output result based on the first initial result and the second initial result comprises:
performing weighting processing on the first initial result and the second initial result to obtain the target evaluation result for evaluating the accuracy of the target output result.

12. The method of claim 6, further comprising:
under the condition that two or more evaluation models are used for evaluation, obtaining an overall evaluation result for evaluating the accuracy of the target output result based on the target evaluation result of each evaluation model; and
revising the M training sample data based on the overall evaluation result to obtain revised M training sample data;
wherein the method further comprises:
fine-tuning the target model based on the revised M training sample data to obtain a revised target model;
and/or
fine-tuning the evaluation model with the adjustable parameter based on the revised M training sample data to obtain a revised evaluation model.

13. A voice interaction method, comprising:
obtaining target text data, wherein the target text data is obtained based on a speech answer of an object in a previous round of question between the object and an agent;
obtaining a candidate question set in a next round for a question addressed by the target text data; and
inputting the target text data and the candidate question set in the next round for the question addressed by the target text data into a target model to obtain a text question to be generated by the agent.

14. The method of claim 13, further comprising:
converting the obtained text question into a speech question and outputting the speech question.

15. The method of claim 13, further comprising:
obtaining a speech answer of the object for the previous round of question; and
converting the speech answer of the object for the previous round of question into the target text data.

16. The method of claim 13, wherein the candidate question set in the next round for the question addressed by the target text data is determined based on a finite state machine capable of representing a group of questions generated by the agent and a transfer condition for transferring from a current question to the next question; the transfer condition is related to an answer content of the object to reply to the current question.

17. An electronic device, comprising:
at least one processor; and
a memory connected in communication with the at least one processor,
wherein the memory stores an instruction executable by the at least one processor, and the instruction, when executed by the at least one processor, enables the at least one processor to execute the method of claim 1.

18. An electronic device, comprising:
at least one processor; and
a memory connected in communication with the at least one processor,
wherein the memory stores an instruction executable by the at least one processor, and the instruction, when executed by the at least one processor, enables the at least one processor to execute the method of claim 13.

19. A non-transitory computer readable storage medium storing a computer instruction wherein the computer instruction causes a computer to perform the method of claim 1.

20. A non-transitory computer readable storage medium storing a computer instruction wherein the computer instruction causes a computer to perform the method of claim 13.
